(19) United States
(12) Patent Application Publication
(10) Pub. No.: US 2008/0204713 A1
(43) Pub. Date: Aug. 28, 2008

(54) Methods and Apparatus for Label-Independent Monitoring of Biological Interactions on Sensitized Substrates

(76) Inventors: Pierre F Indermuehle, Hayward, CA (US); Manfred Heidecker, Hayward, CA (US); Stephane Follonier, Hayward, CA (US); Peter Wagner, Emerald Hills, CA (US)

Correspondence Address: KLARQUIST SPARKMAN, LLP, 121 SW SALMON STREET, SUITE 1600, PORTLAND, OR, 97204, US

(21) Appl. No.: 11/628,496

(22) PCT Filed: Jun. 3, 2005
(86) PCT No.: PCT/US2005/019691

§ 371 Date: Feb. 8, 2008

Related U.S. Application Data
(60) Provisional application No. 60/577,250, filed on Jun. 3, 2004.

(51) Int. Cl. G01N 21/00; C23F 1/00; B29C 59/00; G01N 1/10; G01B 9/02; G06F 19/00; G01J 4/00; B29C 65/00

(52) U.S. Cl. 356/72; 216/24; 264/293; 156/60; 356/365; 356/246; 702/85; 356/73; 356/521

(57) ABSTRACT

Sensor interrogation systems based on optical phase changes are configured to quantify analytes. Sensor chips and wells can include light scattering regions, light absorbing regions, or tilted regions to reduce or eliminate unwanted portions of an interrogation optical beam. In some examples, a spatial phase modulation is used to compensate static birefringence or to provide a selected sensor bias point. Phase changes can be detected based on state of polarization using interferometry. Optical resonator structures can be used to enhance phase changes to simplify detection of optical phase changes.

### CROSS REFERENCE TO RELATED APPLICATIONS

This application claims the benefit of U.S. Provisional Patent Application 60/577,250, filed Jun. 3, 2004 that is incorporated herein by reference.

### TECHNICAL FIELD

The disclosure pertains to method and apparatus for detection of molecular binding.

### BACKGROUND

Biomolecular sensor systems have been developed for detection of a variety of analytes. In most common applications, each analyte is associated with a capture agent and a tagged detection agent (forming a “sandwich complex”). The capture agents are immobilized on a substrate surface, and the substrate is exposed to a sample solution so that portions of any analytes associated with the binding agents are captured. After analyte binding, the substrate is exposed to a detection agent cocktail complementing each of the capture agents. Typically, the detection tags are configured to specifically bind to the captured analytes and to fluoresce when exposed to readout illumination. By measuring the fluorescence signal associated with each of the capture agent/tagged detection agent pairs, the associated analytes can be traced and quantified.

While such sensor systems can be convenient to use, and provide accurate, sensitive detection of many biomolecules in various samples, these systems require development of a capture agent/tagged detection agent pair (sandwich pair) for each analyte of interest. Such development tends to be time consuming and expensive. In some cases, it is difficult to obtain a sandwich pair that can bind to an analyte of interest. For example, in systems that use antibodies for capture and detection, an analyte can include only one suitable binding site (epitope) and a suitable pair may be unavailable. Thus, such sensor systems are typically limited to the detection of a relatively small number of analytes. Accordingly, sensor systems and methods are needed that do not rely on sandwich pairs for the detection of analytes in samples.

### BRIEF DESCRIPTION OF THE DRAWINGS

FIG. 1A is a plan view of a representative arrangement of activated areas defined on a surface of a substrate.

FIG. 1B is a sectional view of a row of pillars that extend from a substrate and have activated areas defined pillar top surfaces.

FIG. 1C is a sectional view of a microwell plate that includes a plurality of microwells in which one or more activated areas are defined.

FIG. 2A is a plan view of a substrate that includes two channels having sensitized pillars and light scattering intermediate regions.

FIGS. 2B-2C are representative arrangements of scattering features in portions of the intermediate region of FIG. 2A.

FIG. 2D is a sectional view of the scattering feature arrangement of FIG. 2C.

FIG. 2E is a sectional view of a portion of a mask that includes portions configured to define roughened surface regions and a pillar.

FIG. 2F is a sectional view of a sensor chip defined using the mask of FIG. 2E.

FIGS. 3A-3C are sectional views of additional scattering, diffracting, or reflecting features.

FIG. 4A is a schematic diagram of an ellipsometric system configured to interrogate a sensor chip.

FIG. 4B is a plan view of a gasket configure to provide a fluid seal between a sensor chip and an optical surface.

FIGS. 4C-4E are representative sectional views of gaskets such as the gasket of FIG. 4B.

FIG. 4F is a plan view of another exemplary gasket.

FIG. 4G is a schematic diagram of an ellipsometric system similar to that of FIG. 4A.

FIG. 5 is a schematic diagram of an interferometer system for interrogation of a sensor chip.

FIGS. 6A-6D are schematic diagrams of interrogation optical systems that provide multiple interactions with a sensitized surface.

FIG. 7A is a representative image of a sensor chip.

FIG. 7B is an interrogation system that includes a two-dimensional liquid crystal waveplate configured to associate a spatially varying birefringence with a sensor chip surface. For convenience, the interrogation system is shown schematically using near normal incidence, but sample angles of incidence are generally selected based on conventional ellipsometric considerations. Front side illumination is shown in FIG. 7B.

FIG. 7C is a schematic diagram of an interrogation system similar to that of FIG. 7B, but configured to interrogate sensitized areas defined in one or more wells of a well plate. As shown in FIG. 7C, back side illumination is used.

FIG. 8 depicts a flow cell that includes a prism configured to deliver an optical flux to a sensor chip.

FIG. 9A-9C illustrate well plates having non-parallel surfaces.

### DETAILED DESCRIPTION

Disclosed below are representative methods and apparatus. The disclosed methods should not be construed as limiting in any way. Instead, the present disclosure is directed toward novel and non-obvious features and aspects of the various disclosed embodiments, alone and in various combinations and sub-combinations with one another. The methods and apparatus are not limited to any specific aspects or features, or combinations thereof, nor do the methods and apparatus require that any one or more specific advantages be present or problems be solved.

Although the operations of the disclosed methods and apparatus are described in a particular, sequential order for convenient presentation, it should be understood that this manner of description encompasses rearrangement, unless a particular ordering is required by specific language set forth below. For example, operations described sequentially may in some cases be rearranged or performed concurrently. Additionally, the detailed description sometimes uses terms like “determine,” “provide,” and “interrogate” to describe the disclosed methods. These terms are high-level abstractions of the actual operations that are performed. The actual operations that correspond to these terms will vary depending on the particular implementation and are readily discernible by one of ordinary skill in the art.

Some described examples are based on ellipsometric measurements. Ellipsometric systems typically include an initial polarizer, a compensator, and a second polarizer that is often referred to as an analyzer. In typical sample evaluations, components are arranged as initial polarizer, compensator, sample, second polarizer or initial polarizer, sample, compensator, second polarizer, but other configurations are possible. For convenience, in some examples polarizer and analyzer can refer to a combination of a polarizing device and a compensator such as a waveplate. The disclosed examples generally are based on imaging of a plurality of differently activated areas so that an analysis of many analytes can be performed with a single image, or a time evolution of analyte bindings can be assessed using a series of such images.

Surface treatments associated with specific binding of selected analyte molecules can be applied to a variety of surfaces. For example, a surface can be treated to specifically bind a selected analyte, while other analytes do not bind to the surface. A surface can be provided with one or more such surface treatments for one or more analytes. For example, a surface can be configured with specific surface regions configured for different analytes and/or some surface regions can be configured to provide controls for calibration and verification of binding of one or more analytes. Substrates can be variously configured. For example, substrates such as fused silica, glass, silicon, polymers, plastics, or other materials can be provided with a substantially planar surface to which surface treatments are applied for binding of one or a variety of analytes of interest on different activated areas. Alternatively, a substrate can be provided with pillars having top surfaces that are treated for binding of one or a variety of analytes of interest on different activated areas. One example of such binding is protein-protein binding that can be used in, for example, proteomics. Such pillars and representative surface treatments are described in Jedrzejewski et al., U.S. Pat. No. 6,730,516 and Wagner et al., U.S. Pat. No. 6,596,545 that are incorporated herein by reference. In other examples, depressions or wells can be provided in a substrate, and bottom surfaces of the wells can be similarly treated. Typically, pillars, wells, or activated areas on a planar surface are arranged in arrays, and are conveniently separated by intermediate areas that are not provided with such surface treatments. In some examples, the intermediate areas are treated to reduce or minimize any type of binding.

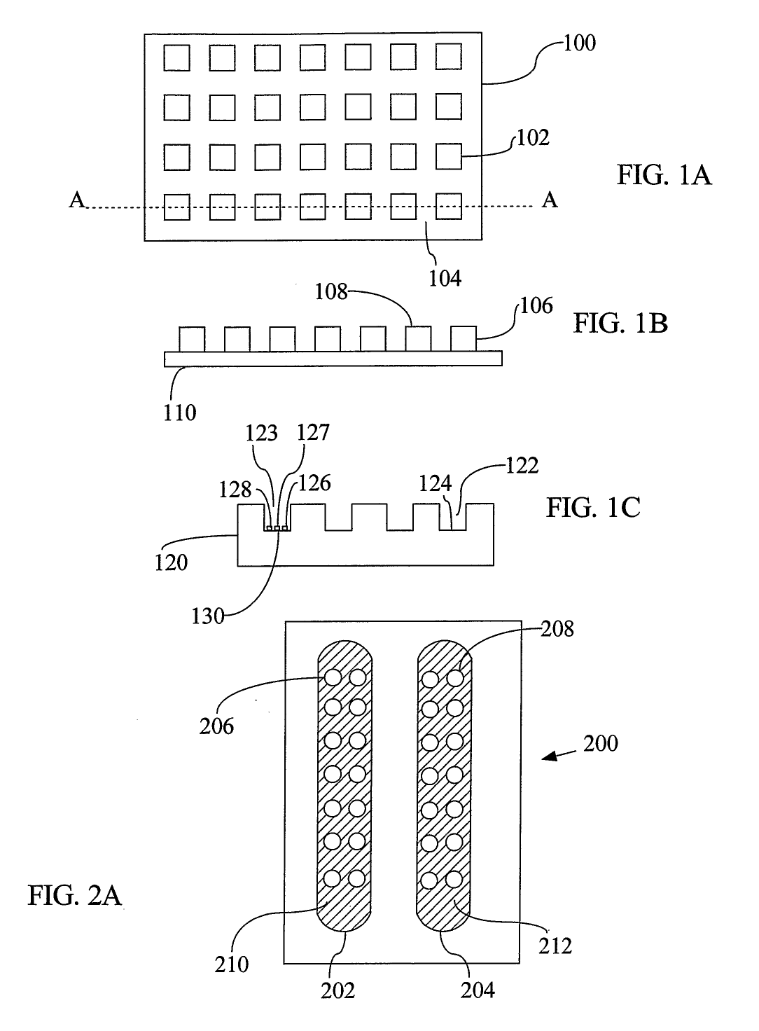

A representative example of a sensor is illustrated schematically in FIG. 1A. A substrate 100 is provided with activated sensor areas (“regions of interest or “ROIs”) 102 that are arranged in an array. The ROIs 102 are separated by an intermediate region 104 that can be substantially untreated, or treated to substantially reduce binding of any analyte. The ROIs 102 and the intermediate region can be defined on a single surface, conveniently on a planar surface, or they can be defined in different planes. For example, with reference to FIG. 1B, the ROI 108 can be defined on top surfaces of pillars 106 that extend from a surface 108 of a substrate 110. In another example, a microwell plate 120 includes an array of wells such as representative well 122 that includes an ROI defined on a surface 124 of the well as shown in FIG. 1C. Alternatively, wells such as representative well 123 can include a plurality of ROIs 126, 127, 128 defined on a surface 130 of the well 123. Typically, the ROIs are separated by intermediates region that lack substantial activation, but in other examples, ROIs lack such separation. For example, ROIs targeted for different analytes can be adjacent on a substrate such as a well surface. In other examples, the ROIs can be separated by light scattering, light reflecting, or light absorbing areas.

Sensors that include wells or pillars can be interrogated optically as discussed below. Interrogation systems can include optical paths in or associated with such sensors that are reflective or transmissive, or a combination thereof. In addition, an interrogating optical flux can be incident to a ROI directly or incident through a substrate on which the ROI is defined. Interrogation of an ROI without passage of the interrogating flux through a substrate can be referred to as “front side” interrogation, and interrogation through a substrate can be referred to as “back side” interrogation. Back side sensor interrogation can use total internal reflection (TIR), and sensor ellipsometric interrogation apparatus can be configured for “Total Internal Reflection Ellipsometry” or “TIRE.” For convenience below, some examples are described only in front side or back side configurations, but either type of interrogation can be used. In addition, reflective or transmissive interrogation schemes can be used for both front side and back side illumination, but only selected examples are provided to illustrate typical configurations.

For activated surfaces that include a plurality of activated areas (ROIs) separated by an intermediate, unactivated or de-activated region, optically-based interrogation of analytes bound to the ROIs can be complicated by light reflected or transmitted by the intermediate region. Such optical interrogation can be simplified by providing the intermediate region with an absorbing, scattering, reflecting, diffracting or other surface treatment configured to partially separate or otherwise distinguish portions of an interrogating optical flux that interact with the activated ROIs from portions of the light flux that do not interact with the activated ROIs.

A simple way to make the intermediate regions scatter light is to increase their surface roughness. This can be achieved, for example, by etching the intermediate regions with the appropriate etchant while protecting the sensor regions. Another way to roughen the surface of the intermediate regions is to define patterns in the intermediate region, which will act as an etch mask and such that, after an adequate etching process, only the bottom part of their corresponding features remains. If the sensitized surface is on the top surface of pillars, the etching process and the masking material used to roughen the intermediate regions may or may not be the same as the ones used to build the pillars. The etching process must be somehow isotropic. The lateral dimensions and the pitch of the patterns should be chosen in such a way that the remaining bottom of their corresponding features will generate the desired surface roughness on the intermediate surface. If pillars are used, the lateral dimensions of the roughening patterns should be significantly smaller than the ones of the pillars, so that the top part of the etched features will be etched away while the top part of the pillars remains in place.

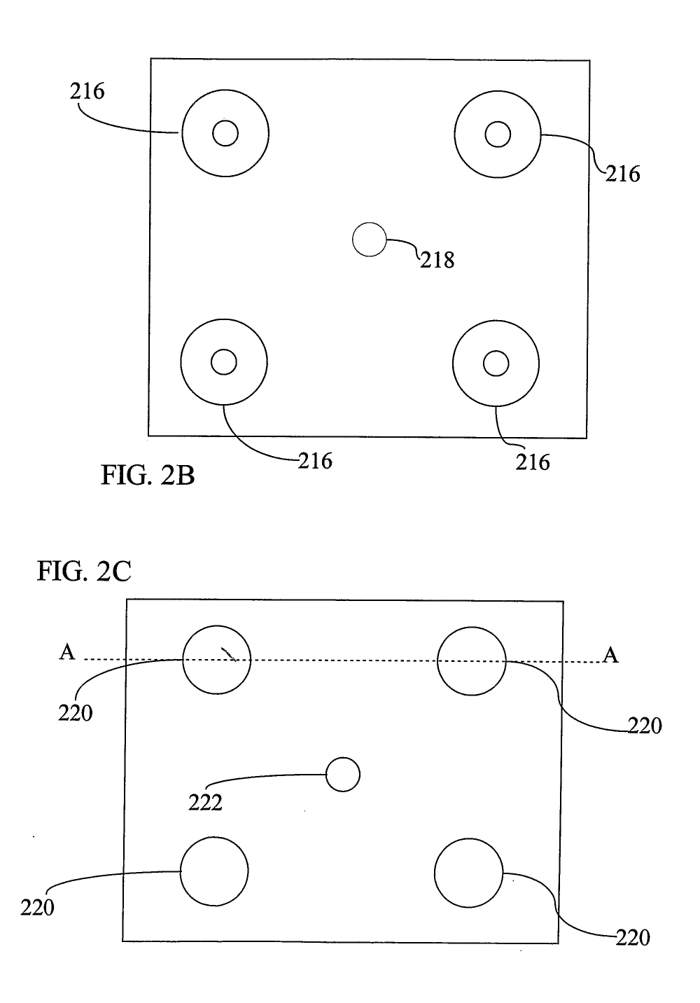

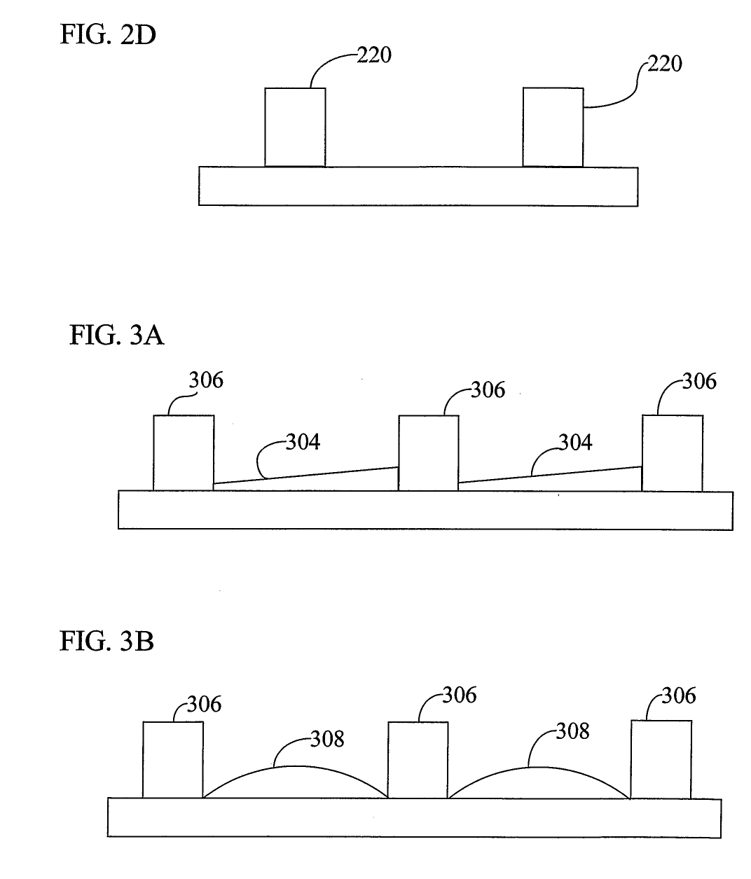

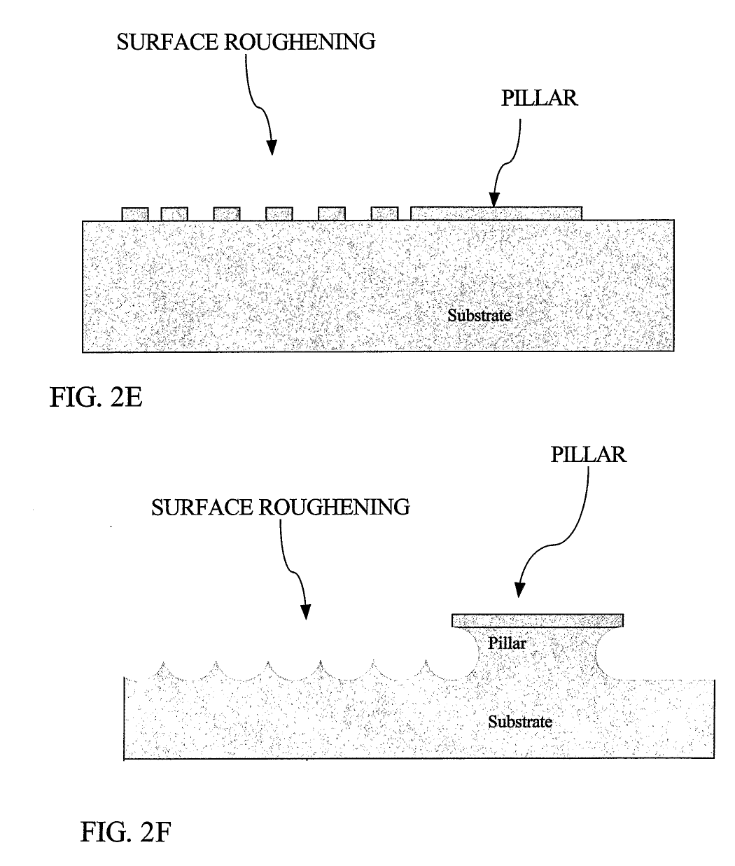

Referring to FIG. 2E, a masking material is patterned on a substrate and is used as a mask for one or more subsequent etching steps. The isotropic process will etch away the top part of the features corresponding to the pattern and designed to roughen the intermediate surface, while the top part of the pillars will remain in place. A representative chip etched in this manner is shown in FIG. 2F.

Referring to FIG. 2A, a sensor chip 200 includes first and second channels 202, 204 that include pillars 206, 208 separated by intermediate regions 210, 212, respectively. As shown in FIG. 2B, the surface of the intermediate regions 210, 212 can be roughened by using a plurality of features generated from patterns such as 216 and consisting of a 12 μm diameter disc and including a 3 μm hole and such as 218, which is a disc with a 6 μm diameter. For convenience, the patterns 216, 218 can be periodically arranged with a period of 42 μm. In other examples, the pattern is a 15 μm diameter disc with a 6 μm hole, and the second pattern is a 8 μm diameter disc, and both are periodically arranged with a 53 μm period. FIG. 2D is a sectional view of the arrangement of FIG. 2C.

In another representative example shown in FIG. 2C, the intermediate regions 210, 212 includes a first scattering feature 220 having a 6 μm diameter and a second scattering feature 222 having a 3 μm diameter that are periodically repeated with a period of 21 μm. In other examples, the first and second scattering features 220, 222 have diameters of 9 μm and 4.5 μm, respectively, and are spaced at a period of 32 μm. The examples of FIGS. 2B-2C are representative only, and other arrangements can be provided. Typically, such scattering features can be defined using conventionally lithographic patterning and etching processes. In some examples, scattering or reflective features can be defined in a substrate in a molding or embossing process. Alternatively, scattering or reflective features can be applied to a sensor surface. For example, a scattering substrate can be glued or fused to a sensor substrate so that the scattering substrate and the sensor substrate can be independently fabricated. In other examples, an intermediate surface region is roughened by exposure to an etchant such a HF etch, with or without lithographic patterning. In other examples, surface roughening can be accomplished with bead blasting, or surface grinding. A surface can be configured to provide directional scattering or random scattering, and interrogation optics are correspondingly configured. In other examples, absorbing intermediate regions are provided.

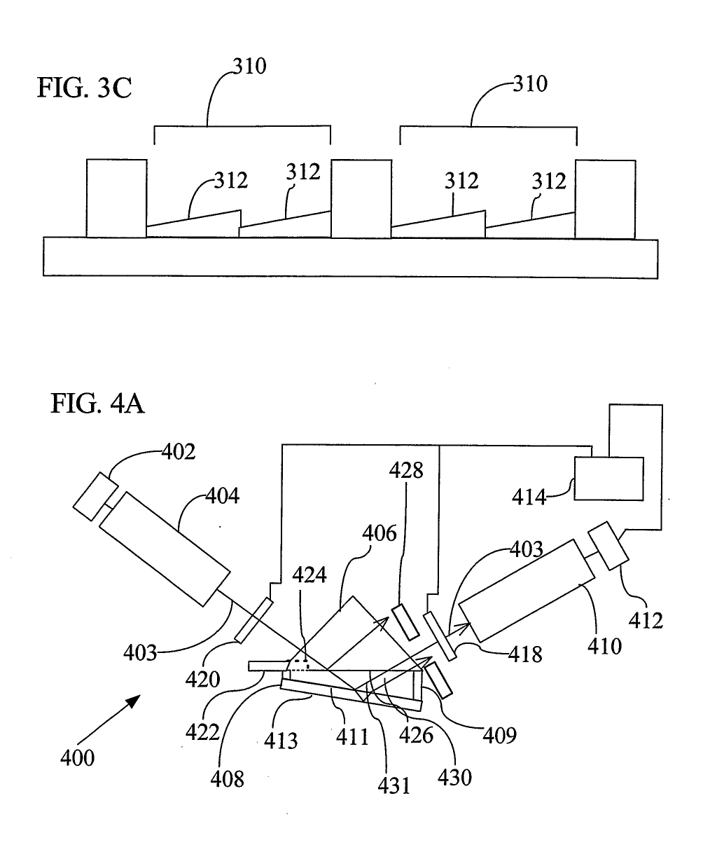

FIGS. 3A-3C are sectional views of additional examples of intermediate regions that are provided with light scattering or reflecting regions. In FIG. 3A, the intermediate region is provided with inclined surface areas 304 that are tilted with respect to pillar surfaces 306 that are configured for analyte binding. In FIG. 3B, the intermediate region is provided with curved surface areas 308 that are configured to reflect incident light in a range of directions. In FIG. 3C, a periodic array 310 of inclined areas 312 is provided, and in some examples, can be similar to a surface area of a blazed diffraction grating. As noted above, the activated ROIs can be defined on a planar or other surface or on surfaces of wells. ROIs are shown on pillars as a convenient example.

Sensor chips that include one or more activated ROIs configured to bind selected analytes can be optically interrogated based on either the real or imaginary part of analyte refractive index, or a combination thereof. For example, an analyte as bound to a patch can produce a change in optical absorbance that can be detected and used to quantitate analyte concentration in a sample or bound analyte mass or volume. In some examples, additional tagging steps are used to bind a tag such as a fluorescent tag to bound to the patch, and analyte presence and/or concentration can be estimated based on fluorescence. However, measurements based on analyte refractive index do not require tagging. For example, an analyte can be detected or quantified based on a change in optical phase or reflectance produced by bound analyte without tagging such as in ellipsometry. Alternatively optical interference produced by the bound analyte can be evaluated.

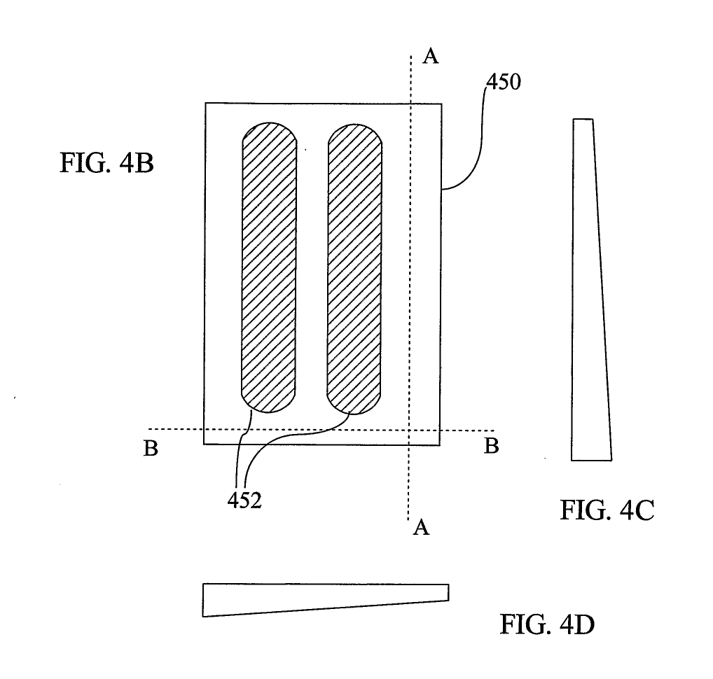

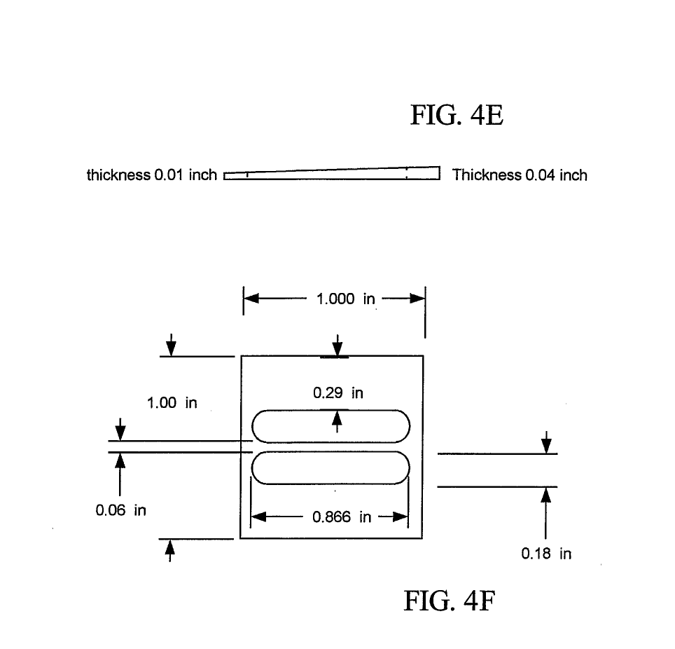

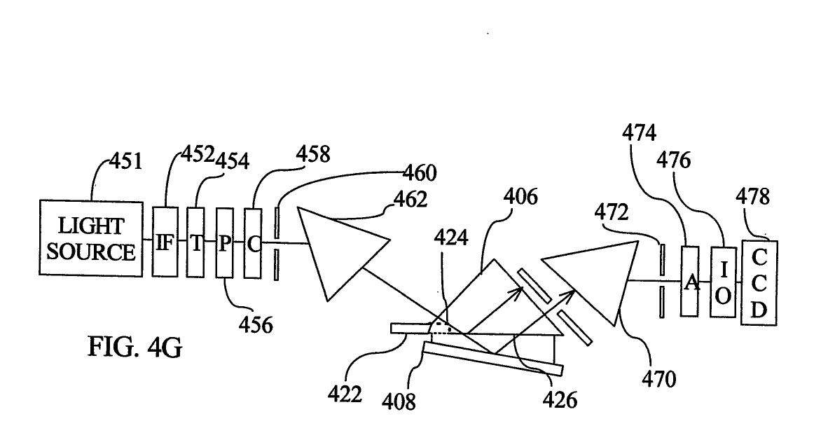

With reference to FIG. 4A, an ellipsometric analysis system 400 includes a light source 402 configured to deliver an illumination beam to a state of polarization (SOP) controller 404. The SOP controller 404 is generally configured to deliver an elliptically polarized illumination beam along an axis 403 to a sensor chip 408 through a sample prism 406 that is typically an equilateral prism of glass or fused silica. The illumination beam is reflected from the sensor chip 408 (typically from at least some activated ROIs on the sensor chip) and delivered to an SOP analyzer 410 and an imaging detector 412 such as a CCD camera or other one or two dimensional imaging detector. As shown in FIG. 4A, the sensor chip is formed on a silicon substrate, but other substrates can be used. Either front side illumination or back side illumination can be provided, and a front side optical path 431 and a back side optical path 430 are shown. The back side optical path passes through the sensor chip 408, and the illumination beam is reflected by an activated surface 413 of the sensor chip. The front side optical path includes reflection at an activated surface 411 of the sensor chip. Typically, either front side or back side illumination is selected, and only a single surface of the sensor chip 408 is activated. A transmissive optical path based on either front side or back side illumination can be used instead of the illustrated reflective optical path. In some examples, such ellipsometric apparatus can be referred to as TIRE apparatus.

The illumination beam is typically collimated and used to produce an image of an array of sensor patches. Additional SOP compensators 418, 420 can be provided to adjust, select, or compensate SOP at selected positions in the illumination beam. For example, a liquid crystal waveplate array can be configured to adjust SOP for each pixel or selected pixels in the image of the sensor chip surface. Compensation can be selected to reduce the effects of component birefringence, or to select a bias point for ellipsometric analysis so that, for example, a change in thickness of material deposited on a ROI is associated with a substantial or maximal change in the associated portion of the image signal. Alternatively, one or both of the liquid crystal panels can be configured to set transmission for each ROI to a low level or a minimum, similar to the configuration used in so-called null ellipsometry. In a specific example, bias can be selected for “off-null” ellipsometry in which detected optical intensity is proportional to a square of layer thickness.

Samples can be delivered to the sensor chip via a dispenser tube 422 that is situated in a groove 424 that is formed in a sensor prism face 426 of the sample prism 406. A sample volume is defined by the prism face 426, the sensor chip 408, and a gasket 409. As shown in FIG. 4A, the gasket 409 is wedged, and thus has a variable thickness. Sample volumes can be about 50 μl or less. In other examples, a gasket having a substantially constant thickness can be used, and wedge introduced by application of different forces to different ends of the gasket. Such a configuration can introduce additional birefringence and a wedged gasket is generally more convenient. A portion of the illumination flux that is reflected by the prism face 426 and unmodulated by interaction with bound analyte at the sensor chip is reflected to an aperture plate 428, and blocked. Thus, this portion does not reach the image sensor, or is substantially attenuated at the image sensor 412. In some examples, an aperture plate is unnecessary due to the magnitude of the angular deflection of this portion of the flux from the axis 403, and in other examples, the aperture plate is located downstream of the SOP analyzer 410. In other examples, an additional optical element such as a lens can be used to focus the substantially collimated flux from the sensor surface through an aperture plate or pinhole that is situated to block or attenuate the unmodulated portion. Wedge angles of about 1.5 degrees are satisfactory in some example. By configuring the unmodulated reflected beam and the modulated reflected beam to propagate along non-collinear or tilted axes, contributions of the unmodulated beam to a detected signal can be reduced or eliminated, increasing detection sensitivity to unlabeled or other analytes. As shown in FIG. 4A, a reflected, unmodulated portion of the interrogating optical flux can be blocked by an aperture, but in other examples a lens can be situated to receive both the modulated and unmodulated portions and an aperture such as a pinhole can be situated to transmit the modulated portion and block the unmodulated portion. Appropriate collimating or beam shaping optics can be used to direct the spatially filtered beam to the image sensor.

The image sensor 412 is in communication with a signal processor 414 that is configured to provide an estimate of analyte presence based on the image signal from the image sensor. The signal processor 414 can be a personal computer such as a desktop computer, a workstation, a networked computer, a personal digital assistant, or a dedicated microprocessor system. The signal processor 414 generally is configured to receive calibration parameters for the sensor chip using a floppy disk or other removable computer readable media, or from a network connection, or other input device. In addition, at least some sensor ROIs can be provided for calibration, and the signal processor can determine analyte response parameters such as slope and offset based on these ROIs.

A schematic plan view of a representative gasket 450 suitable for use with the apparatus of FIG. 4A is shown in FIG. 4B. The gasket includes recesses 452 configured to receive pillars arranged in channels such as those configured as shown in FIG. 2A, but can include a single recess or a plurality of recesses. Using a plurality of recesses in the prism or in the gasket or in the substrate, corresponding dispenser tubes can be provided so that several samples can be provided for analysis with a single sensor chip. Representative cross sections of such gaskets are shown in FIGS. 4C-4D. The gasket can also be wedged in other directions. Such a gasket can be conveniently molded or otherwise formed of various compliant materials, and can be wedged along various axes. Additional examples are illustrated in FIGS. 4E-4F.

An alternative ellipsometric system is illustrated in FIG. 4G. A light source 451 is configured to deliver an optical flux to an interference filter or other spectral filter 452, a beam shaping system such as a telescope 454, a polarizer 456, and a compensator 458. The optical flux can be further shaped or confined by a slit or other aperture 460, and directed to the prism 462 and the sensor chip 408. The reflected optical flux is directed to a prism 470 and through a slit or other aperture 472, an analyzer 474, and imaging optics 476 for image formation at a CCD 478.

While phase differences between s and p-polarizations can be interrogated using polarization analyzing optics that include waveplates and polarizers, such phase differences can be interrogating interferometrically as well. With reference to FIG. 5, an interferometric apparatus 500 is configured to receive a modulated optical beam 501 from, for example, a sensor chip. The beam 501 typically includes two orthogonal polarization components (referred to herein as an “s-polarization” and a “p-polarization,” but in some configurations the polarizations are orthogonal circular or elliptical polarizations) that have a phase difference associated with analyte adhesion to one or more activated ROIs on a sensor chip. Typically, the beam 501 includes a plurality of such phase differences that are spatially distributed in a plane perpendicular to a beam propagation axis. The beam 501 is directed to a polarizing beamsplitter 502, and a s-polarization component is directed to a retardation plate 506 that is situated to change the polarization to a p-polarization. Reflectors 510, 512 direct the p-polarized components to a beamsplitter 504, and first and second interference output beams 515, 516 are produced. One or both of the output beams 515, 516 can be directed to respective image sensors to produce image signals associated with analyte binding to one or more activated ROIs. While the example of FIG. 5 shows conversion of an s-polarization to a p-polarization, in other examples, the p-polarization component can be converted to an s-polarization, or other orthogonal polarization components can be processed to have components along a common axis so that an interference signal can be produced.

The interference patterns produced by the beams 515, 516 can be adjusted based on a path difference associated with a first path 520 and a second path 522. For example, the phase difference between the two components of the beam 515 can be selected to be 0 degrees, 45 degrees, 90 degrees, 180 degrees, or some other value either in the presence of a selected analyte phase contribution or in the absence of analyte. In this manner, an interferometric transfer function can be selected. Using a spatial light modulator such as an LCD module to provide spatial local phase correction (SPLC), the transfer function can be selected as a function of location in the sensor image as well. In some examples, a phase difference is initially selected for some or all ROIs so that the associated portion of the interrogation optical beam is minimized, and increases in optical beam intensity can be associated with analyte binding. Alternatively, an initial bias can be selected so that a rate of change of optical beam intensity as a function of bound analyte is a maximum for some or all ROIs. A phase shifter can be provided in an optical path, and a control signal applied to the phase shifter to return from an as-exposed optical beam intensity to a pre-exposure intensity used to estimate analyte binding.

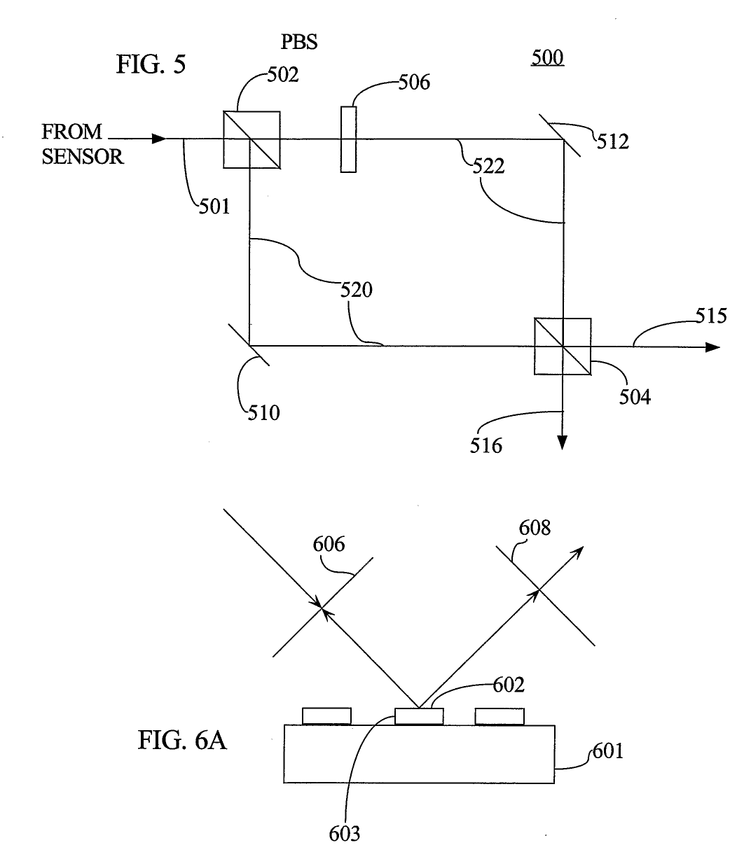

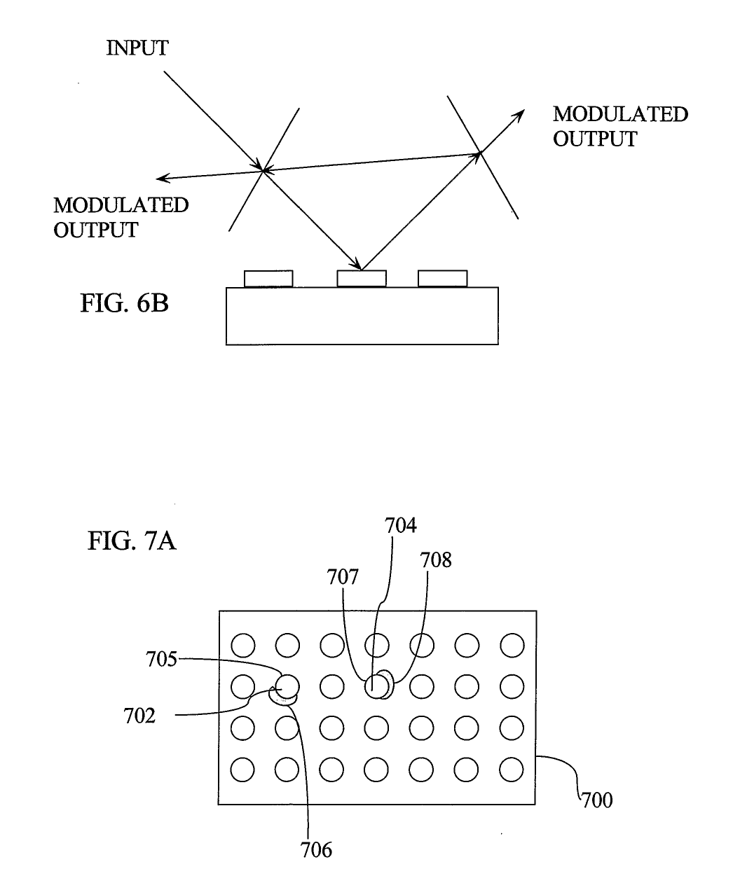

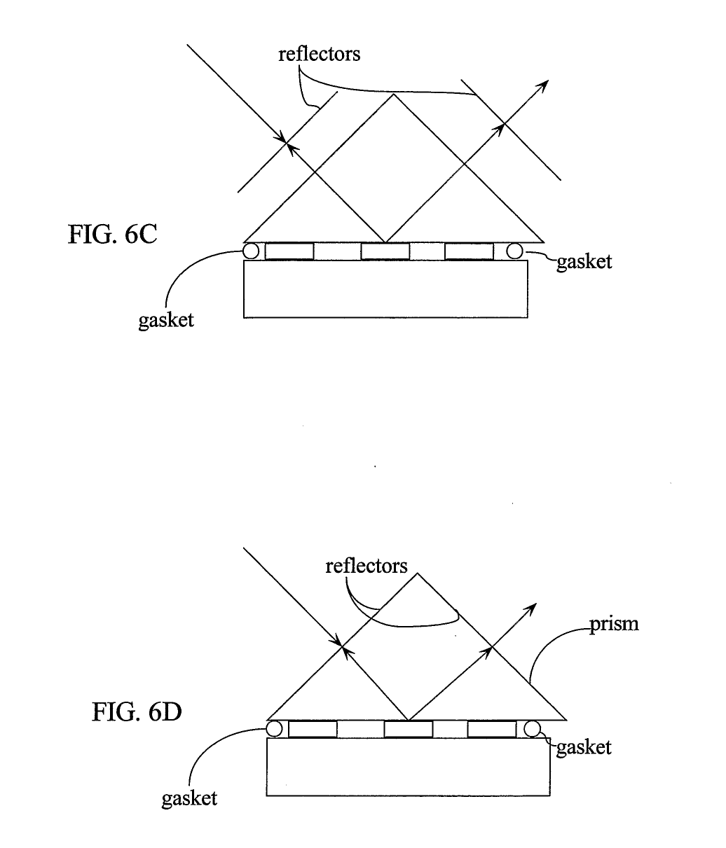

Typically the phase changes produced by interaction with a bound analyte are relatively small, and thus can be difficult to measure reliably. Referring to FIG. 6A, an unmodulated optical beam is delivered to a representative sensitized top surface 602 of a pillar 603. Generally an array of such pillars is exposed to the unmodulated optical beam, but interaction with a single pillar is described for convenience. The unmodulated beam is at least partially transmitted by a reflective surface 606 to the surface 602 and reflected to a reflective surface 608. The reflective surfaces 606, 608 are configured so that the beam typically is reflected so as to interact with the surface 602 several times. An average number of interactions can be estimated based on the reflectances of the surfaces 606, 608 and associated with a “Q” of the resonant cavity formed by the surfaces 606, 608. Beams associated with one, two, or other numbers of interactions with the surface 602 can be detected using a pulsed beam and time resolved detection. Either or both of the reflectors 606, 608 can be configured to transmit a modulated light flux to an image sensor for processing. The resonator configuration of FIG. 6A corresponds to a Fabry-Perot configuration, but other configurations can be used. For example, a ring configuration is shown in FIG. 6B. Examples of configurations that use a flow cell that include a prism are shown in FIG. 6C-6D. As shown in FIG. 6D, reflective coatings or other reflectors can be applied directly to prism surfaces. In other examples, conventional flow cells can be situated to provide multiple interactions with the patches, or wedged gaskets can be used with prism based systems to reduce contributions of unmodulated light. Other sensor configurations, such as, for example, well plates can be similarly interrogated. In addition, either front side or back side illumination can be used.

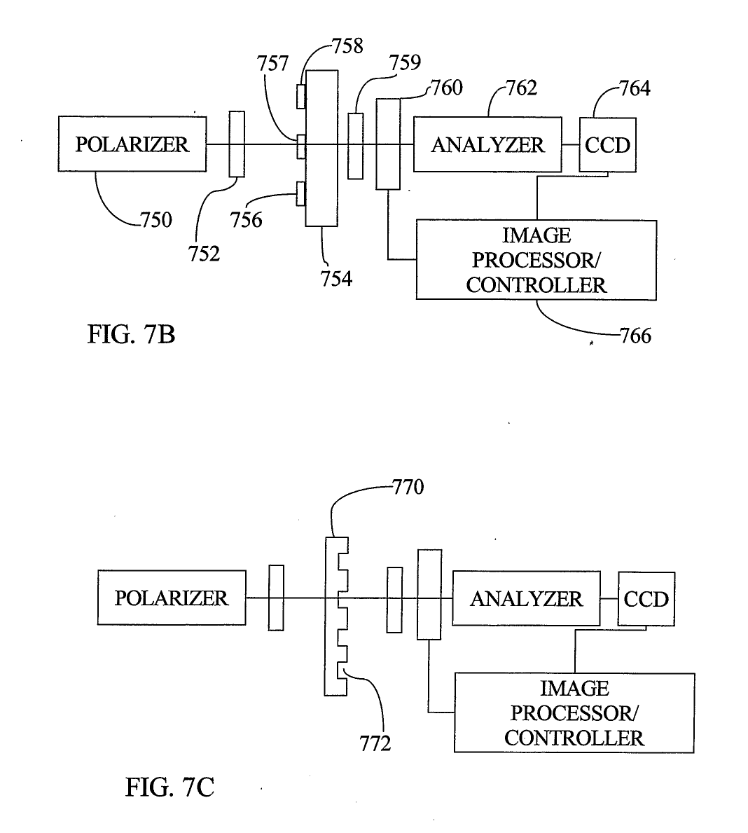

Sensor systems frequently exhibit undesirable birefringence in, for example, a sample cell or in interrogation optics, and such birefringence can degrade sensor image signals. A representative image 700 of an array of pillars that includes such degradation is shown in FIG. 7A. The image 700 shows representative pillar images 705, 707 that include sensitized surface images 702, 704. Uncompensated image regions 706, 708 are situated adjacent the pillar images 705, 707 and are associated with, for example, birefringence in the optical system used to interrogate the activated ROIs. The uncompensated regions can result in blooming or other artifacts in the image signal. Such artifacts can be reduced or eliminated using the apparatus of FIGS. 7B-7C. As shown in FIG. 7B, a polarizer 750 and compensator 752 are configured to deliver an optical beam having a selected state of polarization to a substrate 754 having sensitized patches 756, 757, 758. After modulation by one or more of the activated ROIs 756, 757, 758 based on, for example, quantities of bound analyte, a modulated beam is delivered to a compensator 759 and a spatial light modulator (SLM) 760. For example, the SLM 760 can include a liquid crystal cell that is addressable with a series of row and column electrodes. Typically, a liquid crystal cell serves as the spatial light modulator and can be configured to apply a selected retardation or phase difference between polarization states to an input beam across a beam width. An analyzer receives the modulated optical beam and directs the analyzed, modulated beam to an image array 764 such as a charge coupled device. The image array 764 produces an image signal that is delivered to a processor/controller 766 that provides estimates of bound analyte thickness, mass, analyte concentration in a sample, or other analyte measurement based on the image signal. The processor 766 is in communication with the SLM 760, and is configured to provide an SLM drive signal to the SLM 760 so that each pixel, or each row or column or other pixel grouping can be associated with a selected retardation or phase difference. In some examples, the SLM 760 is driven by the processor 766 so that undesirable bright regions of a sensor image are darkened to reduce image sensor blooming. In other examples, the SLM is activated so that an average image brightness or other image values are produced. The processor 766 can be configured, based on a patch geometry on a sensor chip and/or one or more alignment markers on the sensor chip, to select image portions associated with activated ROIs and to adjust the SLM 760 to produce selected image values to be associated with de-activated/passive regions. A similar system configured to interrogate one or more wells 772 defined on a well plate 770 is shown in FIG. 7C. Similar systems based on front side illumination, back side illumination, and/or reflective and transmissive illumination can also be used.

While the SLM 760 can be configured to adjust image properties of unsensitized regions, the SLM 760 can also be configured to adjust or select an operating condition for one or more or all sensitized regions in an image. For example, the SLM 760 can be configured so that some or all activated ROIs are biased at a so-called null condition by adjusting optical phase differences/retardations associated with selected SLM pixels. Analyte estimates can be based on SLM drive signals from the processor 760, with the ROI image value adjusted using the SLM to be at a null, a maximum, or a selected intermediate value. In other examples, an image value can be used in conjunction with a SLM drive value to provide analyte estimates. Prior to exposure to an analyte, image values can be selected using the SLM 760. After exposure, image values can be returned to pre-exposure values, and analyte properties estimated based on the necessary SLM adjustments. For example, the SLM can be controlled to produce a null condition for each (or selected) activated ROIs, and analyte estimates can be determined based on the associated SLM control signal levels. Such a procedure can be used to, for example, reduce contributions of optical signal amplitude variation (amplitude noise) to analyte measurements.

An SLM can be used as described in ellipsometric or other polarization-based interrogations, and such use is not limited to the representative arrangements illustrated in FIGS. 7B-7C. Such spatial local phase correction (SLPC) of optical signals on a ROI-by-ROI or pixel-by-pixel basis can be used in image enhancement, or SLPC-related values can be used as measures of bound analytes. In addition, SLPC can be used to compensate for variations in properties or quantity of activation agents at the ROIs. In some examples, SLPC can be used to establish detected optical intensities at one or more pixels, so that the detected intensities are selectively placed within a number of bits available to represent pixel values. In other examples, SLPC can be used to null or reduce contributions from unmodulated optical signals (such as reflections from optical system components). In still other examples, spatially local amplitude and/or phase correction (SLAPC) can be used to establish spatially local bias points for systems based on front side, back side, reflective, and transmissive illumination.

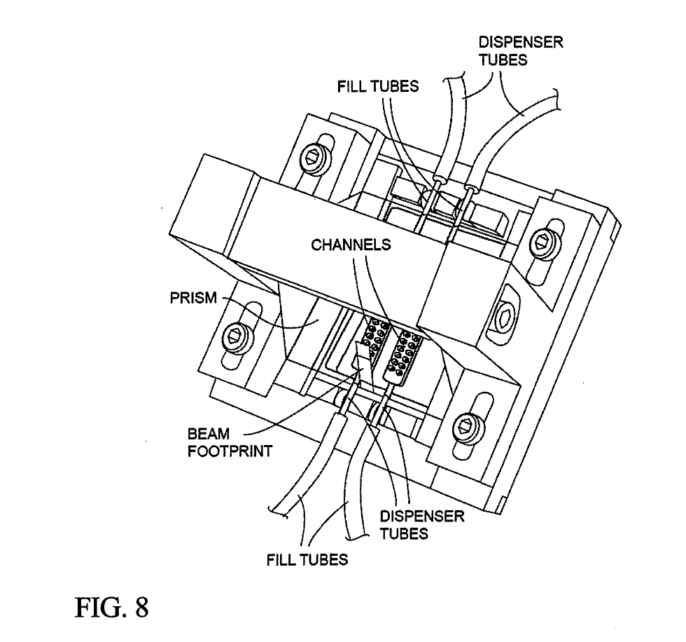

A representative arrangement for exposing a sensor chip to a sample is shown in FIG. 8. Fill tubes and dispenser tubes are configured to deliver a first sample and a second sample to respective channels of a sensor chip. A prism is sealed against a face or a prism with a wedged gasket, and the prism face includes channels that receive the dispenser tubes. Optical beams are directed to the sample chip through the prism, an modulated optical beam are directed by the prism to an analyzer and an image sensor.

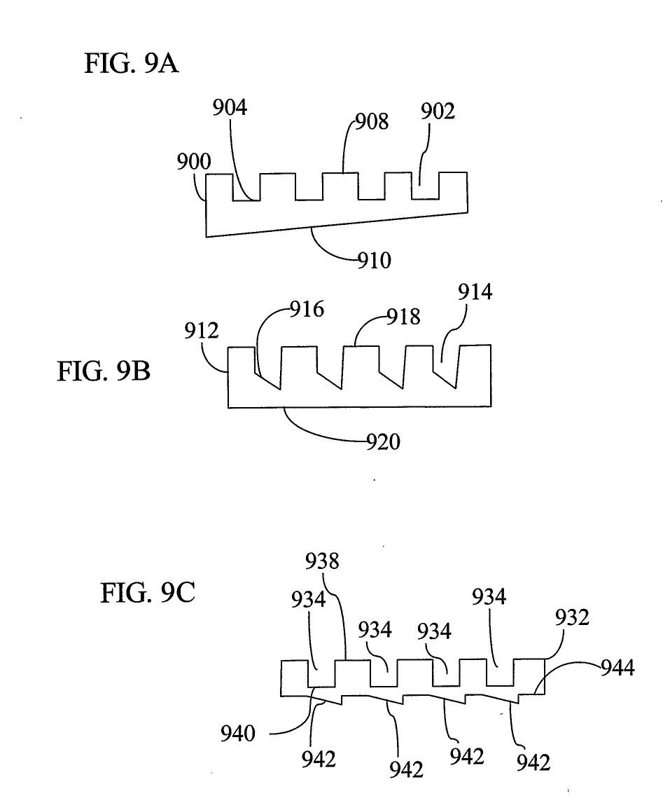

While pillar-based sensor systems can be convenient, well-based systems can also be provided based on reflective or transmissive optical paths, and front side or back side illumination can be used. Well plates can be configured to reduce or eliminate artifacts associated with reflections at unsensitized surfaces. For example, as shown in FIG. 9A, a well plate 900 includes one or more wells such as representative well 902. A sensitized surface 904 is configured to be substantially inclined with respect to a back surface 910 of the well plate 900 and substantially parallel to a front surface 908. In another example, shown in FIG. 9B, a well plate 912 includes wells such as representative well 914. A sensitized surface 916 is substantially tilted with respect to a front surface 918 and is substantially parallel to a back surface 920. In other examples, none of the front surface, the back surface, and the sensitized (activated) surfaces are parallel to each other. In another example, shown in FIG. 9C, a well plate 932 includes a plurality of wells 934 having activated surfaces situated on well surfaces such as the representative well surface 940. A front surface 938 of the well plate is approximately parallel or otherwise situated with respect to the activated surfaces. Associated with each of the wells is a reflective element defined on a rear surface 944 of the well plate. As shown in FIG. 9C, the reflective elements extend outwardly from the rear surface 944, but other configurations can be used. For example, the reflective elements can be associated with recesses in the rear surface 944. Alternatively, one or more conical, hemispherical, cylindrical, or other surface shapes, or an array of such shapes can be situated at the rear surface and associated with the wells to refract, reflect, or scatter light.

While representative examples are described above, these examples can be modified in arrangement and detail, and the examples are not to be taken as limiting the disclosure. Particular combinations of reflective and transmissive optical systems have been described based on front side and/or back side illumination, but other combinations of such optical systems and illumination can be provided. We claim all novel and non-obvious combinations and sub-combinations or the disclosed methods and apparatus, and particular combinations are recited in the accompanying claims.

1. A sensor chip, comprising:
a substrate;
at least one activated (functionalized) region of interest (ROI) defined on the substrate;
at least one light redirecting or at least one light attenuating region on the substrate at least partially surrounding the activated ROIs.

2. The sensor chip of claim 1, further comprising at least one light attenuation region configured to absorb at least a portion of an interrogating illumination flux.

3. The sensor chip of claim 1, further comprising at least one light redirecting region configured to scatter an interrogating illumination flux.

4. The sensor chip of claim 1, wherein the light either the at least one light directing region or the light attenuation region is configured to diffract an interrogating illumination flux.

5. The sensor chip of claim 1, wherein the activated ROIs are defined on respective pillars.

6. The sensor chip of claim 5, wherein the activated ROIs are situated substantially in a common plane, and the at least one light redirecting region or the at least one light attenuation region is defined on a surface displaced from the common plane.

7. The sensor chip of claim 6, further comprising a plurality of light redirecting or light attenuation regions.

8. The sensor chip of claim 6, wherein the at least one light redirecting region includes at least one light scattering feature.

9. The sensor chip of claim 6, wherein the at least one light attenuation region includes at least one absorbing feature.

10. The sensor chip of claim 6, wherein the at least one light attenuation region includes at least one reflecting feature having surfaces that are tilted with respect to the common plane.

11. A method of making a sensor, comprising:
defining a light attenuation region; and
situating activated ROIs so as to be at least partially surrounded by at least one light attenuation region.

12. The method of claim 11, wherein the at least one light attenuation region is defined by forming at least one light scattering region.

13. The method of claim 12, wherein the at least one light scattering region is defined by etching a sensor substrate.

14. The method of claim 12, wherein the at least one light scattering region is defined by embossing a sensor substrate.

15. The method of claim 12, wherein the at least one light scattering region is defined by molding a sensor substrate.

16. The method of claim 12, wherein the at least one light scattering region is defined by applying a scattering substrate to the sensor substrate.

17. The method of claim 12, wherein the activated ROIs are situated on a sensor chip or a well plate.

18. A method of analyzing a sample, comprising:
exposing a sensor chip to the sample;
detecting an illumination flux received from a plurality of activated ROIs defined by the sensor chip; and
redirecting or absorbing portions of the illumination flux from the sensor chip that are not associated with the activated ROIs.

19. The method of claim 18, wherein the portions of the illumination flux that are not associated with the activated ROIs are absorbed or diffracted.

20. An apparatus, comprising:
a first polarizer configured to produce a linearly polarized illumination flux;
a quarter waveplate configured to produce an elliptical beam and direct the illumination flux to sensor surface;
a sensor chip redirecting the illumination flux from the quarter waveplate to the polarizer analyzer;
a polarization analyzer configured to receive the illumination flux from a sensor surface;
an image sensor configured to receive the illumination flux from the polarization analyzer and produce an image signal associated with a change in illumination flux state of polarization at least one sensor surface region;
a processor configured to receive the image signal and produce estimates of analyte presence at the at least one sensor surface region.

21. The apparatus of claim 20, wherein the processor is configured to produce estimates of analyte presence based respective image signal magnitudes associated with corresponding regions of the plurality of sensor surface regions.

22. The apparatus of claim 19, wherein the sensor surface regions are arranged in an array on the sensor surface.

23. The apparatus of claim 22, wherein the array is a two dimensional array.

24. An apparatus, comprising:
a prism having a fluid delivery face; and
a sealing member configured to receive a sensor substrate and define a sample volume extending from the sensor substrate to the fluid delivery surface.

25. The apparatus of claim 24, wherein the prism includes at least one recess defined in the sample delivery face and coupled to deliver a fluid to the sample volume.

26. The apparatus of claim 25, wherein the prism includes at least two recesses defined in the sample delivery face and coupled to deliver a fluid to the sample volume and to receive fluid exiting the sample volume.

27. The apparatus of claim 24, further comprising a sample tube situated in the recess and coupled to the sample volume.

28. The apparatus of claim 24, wherein the prism includes at least one illumination face configured to deliver an incident illumination flux to the sensor delivery face and to receive an illumination flux from the sensor delivery face.

29. The apparatus of claim 24, wherein the prism includes at least one illumination face configured to deliver an incident illumination flux to the sensor delivery face or to receive an illumination flux from the sensor delivery face.

30. The apparatus of claim 24, wherein the prism includes a first illumination face configured to deliver an incident illumination flux to the sensor delivery face and a second illumination face configured to receive an illumination flux from the sensor delivery face.

31. The apparatus of claim 24, wherein the prism includes at least two recesses configured to define at least two flow cells.

32. The apparatus of claim 24, wherein the sealing member is a tapered gasket.

33. A flow cell, comprising:
a prism having a fluid delivery surface and at least one fluid delivery channel; and
a gasket configured to seal a sensor chip to the fluid delivery surface.

34. The flow cell of claim 33, wherein the at least one fluid delivery channel is defined in the fluid delivery surface.

35. The flow cell of claim 33, wherein the at least one fluid delivery channel is defined in the fluid delivery surface.

36. The flow cell of claim 33, wherein the at least one fluid delivery channel is defined in the gasket.

37. The flow cell of claim 33, wherein the prism includes a first surface configured to deliver an optical interrogation beam to the fluid delivery surface.

38. The flow cell of claim 37, wherein the prism includes a second surface configured to receive the optical interrogation beam from the fluid delivery surface.

39. A sensor analysis system, comprising:
an image input configured to receive an image signal associated with at least two activated ROIs;
an output configured to deliver an electrical signal associated with a spatially local amplitude and/or phase correction (SLAPC) to a spatial light modulator (SLM); and
a processor configured to establish the electrical signal based on an image signal received at the image signal input.

40. The sensor analysis system of claim 39, wherein the electrical signal is associated with a reflective SLM.

41. The sensor analysis system of claim 39, wherein the processor is configured to establish the electrical signal based on a selected optical amplitude or phase bias.

42. The sensor analysis system of claim 39, wherein the processor is configured to provide an estimate of at least one detected analyte based on the electrical signal.

43. The sensor analysis system of claim 39, wherein the processor is configured to update the electrical signal based on a received image signal.

44. The sensor analysis system of claim 39, further comprising an optical system configured to deliver an optical flux to a sensor and detect an optical flux received from the sensor chip so that the image signal is associated with a totally internally reflected portion of the optical flux.

45. The sensor analysis system of claim 39, wherein the optical flux is incident to the sensor as a front side optical flux.

46-65. (canceled)

66. The sensor analysis system of claim 39, wherein the optical flux is incident to the sensor as a back side optical flux.

67. The sensor analysis system of claim 39, wherein the activated ROIs are situated on a sensor chip.

68. The sensor analysis system of claim 39, wherein the activated ROIs are situated on a well plate.

69. A method of interrogating an analyte-induced optical amplitude and/or phase shift, comprising:
repetitively directing an illumination flux to activated ROI locations in an assembly of ROI locations;
associating respective portions of the illumination flux with corresponding activated ROIs locations in the assembly of ROI locations; and
estimating analyte presence associated with the ROI locations based on the repetitively directed portions.

70. The method of claim 69, wherein the illumination flux is a collimated light flux.

71. The method of claim 69, wherein the portions are redirected by delivering an image of the patch assembly to the patch assembly.

72. A method of interrogating a sensor chip, comprising:
delivering respective portions of an optical signal having a first state of polarization to a plurality of activated ROIs;
receiving the respective portions of the optical signal and producing corresponding first and second optical polarization components;
processing the first polarization component to have a polarization state configured to produce optical interference when combined with the second polarization component; and
combining the processed first polarization component and the second polarization component to produce an optical interference; and
detecting the optical interference, and based on the detected optical interference, establishing phase shifts and/or amplitude changes at the ROIs.

73. The method of claim 72, further comprising establishing an optical interference bias by selecting a phase difference between the first and second polarization components.

74. The method of claim 72, wherein the portions of the optical signal are received by total internal reflection.

75. An interrogation system for a sensor, comprising:
a polarizing beam splitter configured to direct first and second polarization components of an input optical beam received from the sensor along first and second axes, respectively;
a polarization converter configured to process the first polarization component so as to have a state of polarization that is substantially that of the second polarization component;
a beam combiner configured to combine the processed first polarization component and the second polarization component so as to produce optical interference;
an image sensor configured to produce an electrical signal associated with the optical interference; and
a processor configured to estimate analyte presence at the sensor based on the electrical signal produced by the image sensor.

76. The system of claim 75, wherein the processor is configured to determine a phase difference between the processed first polarization component and the second polarization component and the image signal includes signal portions associated with a plurality of activated ROIs.

77. The system of claim 76, wherein the sensor includes an activated region situated on a surface of a pillar defined on a substrate.

78. The system of claim 75, wherein the input optical beam is directed so as to be reflected at the activated region.

79. The system of claim 75, wherein the input optical beam is configured to be transmitted through the activated region.

80. The system of claim 76, wherein the sensor includes a plurality of activated regions situated on a surface of a well defined in a substrate.

81. The system of claim 56, wherein the sensor includes an activated region situated on a surface of a well defined in a substrate.

82. The system of claim 81, wherein the input optical beam is directed so as to be reflected at the activated region.

83. The system of claim 81, wherein the input optical beam is configured to be transmitted through the activated region.

84. A well plate, comprising:
a substrate having a front surface and a rear surface;
at least one well defined in the substrate and associated with an aperture in the front surface;
a well surface configured for activation, wherein the well surface is substantially tilted with respect to either the front surface or the rear surface.

85. The well plate of claim 84, wherein at least a portion of the front surface or the rear surface is configured to be light attenuating.

86. The well plate of claim 84, wherein at least a portion of the front surface or the rear surface is configured to be light scattering.
